(19) United States
(12) Patent Application Publication
(10) Pub. No.: US 2024/0373880 A1
(43) Pub. Date: Nov. 14, 2024

(54) MEALWORM DIETS FROM BY-PRODUCTS

(71) Applicants: The United States of America, as represented by the Secretary of Agriculture, Washington, DC (US); Beta Hatch, Leavenworth, WA (US)

(72) Inventors: JUAN A. MORALES RAMOS, GREENVILLE, MS (US); MARIA G. ROJAS, GREENVILLE, MS (US); HANS KELSTRUP, BURIEN, WA (US)

(21) Appl. No.: 18/314,726

(22) Filed: May 9, 2023

(51) Int. Cl. A23K 50/90; A23K 10/35; A23K 10/38

(52) U.S. Cl. CPC A23K 50/90; A23K 10/35; A23K 10/38

(57) ABSTRACT

Diets are described to increase productivity and reduce costs for the production of mealworm protein. Scalable, inexpensive, waste-free, and environment-friendly compositions using combinations of multiple by-products and food ingredients in the optimal proportions to optimize mealworm nutritional needs are described. The cost per kg of the new diets is similar or substantially lower than wheat bran, while at the same time improving growth, shortening development time, and increasing food conversion efficiency compared with wheat bran alone.

### BACKGROUND OF THE INVENTION

Good protein sources play a very important role in the search for better quality and more efficient food production. Yellow mealworm (Tenebrio molitor L.) is an important insect with the various potential uses including use as a protein source. Insect meal has emerged as an alternative protein source with many important applications.

The production costs of mealworm protein are mostly driven by mealworm diet costs and current diets are somewhat expensive. Current diets for the yellow mealworm used in commercial production consist mostly of wheat bran or meal run, which are sometimes supplemented with slices of fresh vegetables or fruit including potato, carrot, apple, cabbage, etc. Agricultural by-products have been used as a feed alternative for mealworms, but the use of a single source of by products have yielded inferior growth response as compared with wheat bran.

Thus, there is a need in the field for efficiency in diets for mealworms that have the potential to increase productivity and reduce costs for the production of mealworm products and protein for food and animal feed applications.

### SUMMARY OF THE INVENTION

Diet formulations include different combinations and proportions of ingredients including wheat bran, dry potato, corn dried distiller's grains (DDGS), crude rice bran, defatted rice bran, canola meal, brewery distiller's grains, peanut hulls, and oat hulls.

Mealworm diets with potato flour, corn dried distiller's grains, rice bran whole, rice bran defatted, canola meal, and oat hulls are described. Diet administration to mealworms results in development time of mealworms in as few as 122 days.

A diet with weight percent of at least about 20% potato flour, 10% corn dried distiller's grains, 20% rice bran whole, 36% rice bran defatted, 7% canola meal, or 7% oat hulls is exemplified.

An exemplified mealworm diet with wheat bran, corn dried distiller's grains, rice bran whole, brewery distiller's grainsand oat hulls is described. The diet administration results in a development time of mealworms is few as 166 days. The diet is exemplified by ingredients with a weight percent of at least 30% wheat bran, 20% corn dried distiller's grains, 35% rice bran whole, 10% brewery distiller's grainsor 5% oat hulls.

A mealworm diet which includes wheat bran, potato flour, corn dried distiller's grains, rice bran whole, rice bran defatted, canola meal, brewery distiller's grains, and oat hulls is exemplified. Administering said diet results in the development time of mealworms is as few as 144 days. The diet is exemplified by ingredients with a weight percent of at least 10% wheat bran, 18% potato flour, 10% corn dried distiller's grains, 29% rice bran whole, 11% rice bran defatted, 10% canola meal, 7% brewery distiller's grains, or 5% oat hulls.

A mealworm diet which includes potato flour, corn dried distiller's grains, rice bran whole, rice bran defatted, canola meal, brewery distiller's grains, and peanut hulls. Administering said diet results in the development time of mealworms in as few as 144 days. The diet is exemplified by ingredients with a weight percent of at least 21% potato flour, 10% corn dried distiller's grains, 30% rice bran whole, 12% rice bran defatted, 11% canola meal, 11% brewery distiller's grainsor 5% peanut hulls.

Methods of feeding mealworms by administering a diet comprising wheat bran, potato flour, corn dried distiller's grains, rice bran whole, rice bran defatted, canola meal, brewery distiller's grains, peanut hulls and oat hulls or combinations thereof are described.

### DETAILED DESCRIPTION

Described herein in various embodiments are efficient, scalable, economic, and waste-free, environment-friendly diet formulations and methods of boosting food assimilation, shortened development time, and the high survival rate for administering mealworm diets.

Embodiments describe diet formulations using combinations of agricultural by-products to provide optimal nutrition for the yellow mealworm.

Diet formulations include different combinations and proportions of ingredients including wheat bran, dry potato, corn DDGS, crude rice bran, defatted rice bran, canola meal, brewery distiller's grains, peanut hulls, and oat hulls.

In one aspect, protein content in the diets ranges from 10.5 to 23.8%; lipid content ranged from 4.5 to 11.3%; carbohydrate ranged from 46.9 to 67.2%; and fiber ranged from 24.0 to 47.8%.

In various aspects, different diets described herein show that the diet formulations described produce superior responses in mealworm larvae in biomass productivity, conversion efficiency, development speed and survival compared with larvae being fed by a control diet consisting of 90% wheat bran and 10% dry potato. In another aspect the diet formulations cost per Kg of mealworm live weight produced are lower than a control diet described.

In another aspect, mealworm live weight gained per square meter (m²) was higher in diet formulations described as compared with a control diet. Estimated revenue per m² was higher in the diets as compared with the control diet.

In one embodiment, a method of feeding mealworms by administering a diet that includes ingredients selected from, between 5 and 95weight % wheat bran, between 5 and 95weight % potato flour, between 5 and 95weight % corn dried distillers grains, between 5 and 95weight % rice bran whole, between 5 and 95weight % rice bran defatted, between 5 and 95weight % canola meal, between 5 and 95weight % brewery distiller's grains, between 5 and 95weight % peanut hulls and between 5 and 95weight % oat hulls. In another aspect, the ingredients combined in the diet have ranges of protein content from 10.5 to 23.8%; lipid content ranged from 4.5 to 11.3%; carbohydrate ranged from 46.9 to 67.2%; and fiber ranged from 24.0 to 47.8%.

Diet is a combination of ingredients formulated to fulfill specific nutritional requirements.

Development time is the period of time required to reach the adult stage starting from the time the egg hatches; also known as post embryonic development. Larval development time is the time required by the larvae to reach the pupal stage. Insects have 4 life stages: egg, larva, pupa, and adult.

Grams/100 gram content (g/100 g) is weight percent. For example 20 g/100 g potato flour is 20%.

Dry body weight of larvae is the weight of the larval stage after all its water content has been removed by a drying method.

Wheat bran is bran of wheat. Bran, also known as miller's bran, is the hard layers of cereal grain surrounding the endosperm.

Potato flour is a peeled, cooked potato powder of mashed, mostly drum-dried and ground potato flakes using the whole potato and thus containing the protein and some of the fibers of the potato. It has an off-white slight yellowish color.

Corn dried distiller's grains dry (or corn distilled grain with solubles) are grain byproduct of the fermentation and distillation process to produce ethanol, and consist of residues (protein, fiber, fat) that has been dried with the concentrated thin stillage to 10-12% moisture.

Rice bran whole is a nutrient-rich by-product of the rice milling process. It consists of pericarp, seed coat, nucellus, and aleurone layer.

Rice bran defatted is full fat bran which has been extracted of fat to obtain defatted rice bran.

Canola meal is a brown, free-flowing meal obtained from the extraction of canola oil by the grinding and compressing of canola seeds.

Brewery DG-brewery distiller's grains are a cereal byproduct of the fermentation and distillation process to produce beer. It can consist of corn, rice, barley, oats, wheat, rye and other grains or a mix of any of above mentioned.

Peanut hulls-peanut shells are also called peanut hulls. The nutshell is the outer shell of a nut and covers and protects the kernel.

Oat hulls consist of the outer covering of oat grain after it has been processed to separate the groat (kernel) from the hull.

Dry-weight food consumed: Food was dried in a vacuum oven and weighed before presenting it to the larvae. The food remining (not eaten) was dried again in the vacuum oven, weighed, and the weight was subtracted from the weight of the food added to determine the dry-weight food consumed (FC) for each of the dishes and treatment.

Efficiency of conversion of ingested food is the percentage of food ingested that is converted into live biomass by the insect. The efficiency of conversion of ingested food (ECI) was calculated as ECI=(DWG/FC)×100 for each larval group; where DWG is the. dry weight gained, calculated as the difference between the ending dry weight of the group and the estimated initial dry weight of the group.

Assimilated food (AF) is the amount of food that is converted into biomass, and it was calculated as AF=FC−Frass weight.

Survival rate is the proportion of individuals that remain alive at the end of the experimental period and it is calculated as ending number/initial number.

The term “about” is defined as plus or minus ten percent of a recited value. For example, about 1.0 g means 0.9 g to 1.1 g and all values within that range, whether specifically stated or not.

Unless otherwise explained, all technical and scientific terms used herein have the same meaning as commonly understood by one of ordinary skill in the art to which this disclosure belongs. The singular terms “a”, “an”, and “the” include plural referents unless context clearly indicates otherwise. Similarly, the word “or” is intended to include “and” unless the context clearly indicates otherwise.

It is to be understood that wherever values and ranges are provided herein, all values and ranges encompassed by these values and ranges, are meant to be encompassed within the scope of the present disclosure. Moreover, all values that fall within these ranges, as well as the upper or lower limits of a range of values, are also contemplated by the present application.

Ranges: throughout this disclosure, various aspects of the disclosed subject matter can be presented in a range format. It should be understood that the description in range format is merely for convenience and brevity and should not be construed as an inflexible limitation on the scope of the disclosed subject matter. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Various embodiments of the claims are shown and described herein. It will be obvious to those skilled in the art that such embodiments are provided by way of example only. Numerous variations, changes, and substitutions will occur to those skilled in the art without departing from the embodiments of claims. All publications, patents, and patent applications mentioned in this specification are herein incorporated by reference to the same extent as if each individual publication, patent, or patent application was specifically and individually indicated to be incorporated by reference.

### EXAMPLES

Agricultural by-products including dry corn distilled grain with solubles (DDGS), rice bran (whole and defatted), canola meal defatted, brewery distiller's grain (DG), peanut hulls, and oat hulls, were used to formulate diets for the yellow mealworm (Tenebrio molitor). Four diets were formulated using the above ingredients plus other food ingredients like wheat bran and potato flour to closely match the nutritional requirements of the yellow mealworm (Table 1). The proportions of each ingredients in diet formulations were determined using data from nutrient intake by T. molitor larvae from self-selected proportions of five sets of multiple ingredients with known chemical composition (Morales-Ramos et al. 2020, Self-Selection of Agricultural By-Products and Food Ingredients by Tenebrio molitor (Coleoptera: Tenebrionidae) and Impact on Food Utilization and Nutrient Intake. Insects 11, 827:2-15).

TABLE 1
Diet formulations expressed as g/100 g content
of each ingredient. The content of each ingredient
can range ±10% of the value on the table.

| | Diet 1 | Diet | Diet | Diet | Diet |
|---|---|---|---|---|---|
| Ingredient | (control) | 2 | 3 | 7 | 8 |
| Wheat bran | 90 | | 30 | 10 | |
| Potato flour | 10 | 20 | | 18 | 21 |
| Corn DDGS | | 10 | 20 | 10 | 10 |
| Rice bran whole | | 20 | 35 | 29 | 30 |
| Rice bran defatted | | 36 | | 11 | 12 |
| Canola meal | | 7 | | 10 | 11 |
| Brewery distiller's grains | | | 10 | 7 | 11 |
| Peanut hulls | | | | | 5 |
| Oat hulls | | 7 | 5 | 5 | |

Diets were formulated by mixing dry ingredients in the proportions presented in Table 1 using a high-speed mixer. The dry formulations were mixed with 50% water using a bakery mixer. The mixes were formed into pellets and dried in a vacuum oven at 50° C. and −800 mbar. Diets were evaluated by comparing the growth, survival, and food utilization efficiency of groups of mealworm larvae. Groups of 27 5-week-old larvae were placed in stacked dishes separated by a screen standard No. 35 (500 μm openings). The screen that separated the two dishes was designed to allow the passage of frass particles from the top dish to the bottom dish for collection. Eighteen such groups were selected randomly for each treatment totaling 90 groups for the whole experiment. The initial weight of the larval groups was recorded for each dish and treatment. Larvae were allowed to complete development in an environmental chamber at 27° C., 75% relative humidity, and dark conditions.

Larvae were provided with food as needed and added food was weighed and recorded for each dish and treatment. Frass collected from the bottom dishes was dried in a vacuum oven, weighed, and recorded for each dish and treatment. When larvae reached 15-weeks of age, they were separated from the food, counted, and weighed and the data was recorded for each dish and treatment. The food remining was dried in the vacuum oven, weighed, and the weight was subtracted from the weight of the food added to determine the dry-weight food consumed (FC) for each of the dishes and treatment.

Larvae were returned to their corresponding dishes, provided with new food pellets, and returned to the environmental chamber to complete development. Dishes with larvae were inspected daily for the presence of pupae. Pupation date and pupal weight were recorded along with diet treatment and dish number information. Pupae were separated in petri dishes labeled with diet treatment, dish number, pupation date, and pupal weight and returned to the chamber to complete development. Emerging adults were inspected for defects. Pupal deaths and defective adult molting instances were recorded along with diet treatment and dish number information. Assimilated food (AF) was calculated as AF=FC−Frass weight. The weight of live mealworm biomass gained (LWG) was calculated as the difference between the ending group weight and the initial group weight. The dry weight of larval groups was estimated from the known water content of late-instar T. molitor larvae. These data were generated by weighing individual larvae, freezing them and drying them in a vacuum oven as described above for the food and frass. The percentage dry weight content was then calculated from the weight differences between live and dry larvae. The average of dry weight percentages among 100 larvae was used to estimate the dry weight of larvae in the experiments. Dry weight gained (DWG) was then calculated as the difference between initial and ending dry group weigh. The efficiency of conversion of ingested food (ECI) was calculated as ECI=(DWG/FC)×100 for each larval group.

Results of the evaluation analyses are shown in table 2. Diet 2 produced the most live biomass and was significantly higher than all the other diets. Diet 2 also had the best food assimilation, the shortest development time, and the highest survival than all other diets. Diets 2 and 8 had similar levels of food conversion efficiency (ECI) and both diets were better at conversion efficiency than the rest of the diets. In general, all diets performed better than the control diet (Diet 1).

TABLE 2
Evaluation of food conversion, development, and survival
of Tenebrio molitor fed 5 different diets.

| | Live biomass | Food | | | | |
|---|---|---|---|---|---|---|
| | produced in | assimi- | | Development | Pupal | Survival |
| | Kg/m² of | lation | | time | weight | to adult |
| Diet | rearing space | (%) | ECI** | (days) | (mg) | (%) |
| 1* | 0.92d | 37.38c | 7.16c | 209.86a | 295.85a | 43.42d |
| 2 | 2.1a | 46.86a | 9.74a | 122.77d | 238.26c | 78.6a |
| 3 | 1.56c | 33.41d | 7.12c | 166.18b | 267.67b | 61.73c |
| 7 | 1.82b | 38.14c | 8.14b | 144.88c | 267.46b | 67.28b |
| 8 | 1.85ab | 44.66b | 9.6a | 144.21c | 265.65b | 64.2bc |

Means with the same letter at the right (in order of magnitude) are not significantly different at α = 0.05. Where a mean with the letter ‘a’ is significantly higher than means with the letter ‘b’, ‘c’, or ‘d’ within the same column.
*Diet 1 = control.
**Efficiency of conversion of ingested food (dry-weight basis) ECI = (weight gained/food consumed) × 100.

We claim:

1. A mealworm diet composition comprising potato flour, corn dried distiller's grains, rice bran whole, rice bran defatted, canola meal, and oat hulls.

2. The diet of claim 1 with a weight percent of at least 20% potato flour, 10% corn dried distiller's grains, 20% rice bran whole, 36% rice bran defatted, 7% canola meal, or 7% oat hulls.

3. A diet composition of claim 1 where the efficiency of conversion of ingested food measured by the ratio of dry body weight of mealworms to dry weight of food consumed times 100 is at least about 9.7.

4. A diet composition of claim 1 where the development time of mealworms is as few as about 122 days.

5. A mealworm diet comprising wheat bran, corn dried distiller's grains, rice bran whole, brewery distiller's grains and oat hulls.

6. A diet composition of claim 5 where the efficiency of conversion of ingested food measured by the ratio of dry body weight of mealworms to dry weight of food consumed times 100 is about 7.1.

7. A diet composition of claim 5 where the development time of mealworms is as few as about 166 days.

8. The diet of claim 5 with a weight percent of at least 30% wheat bran, 20% corn dried distiller's grains, 35% rice bran whole, 10% brewery distiller's grainsor 5% oat hulls.

9. A mealworm diet comprising wheat bran, potato flour, corn dried distiller's grains, rice bran whole, rice bran defatted, canola meal, brewery distiller's grains, and oat hulls.

10. A diet composition of claim 9 where the efficiency of conversion of ingested food measured by the ratio of dry body weight of mealworms to dry weight of food consumed times 100 is about 8.1.

11. A diet composition of claim 9 where the development time of mealworms is as few as about 144 days.

12. The diet of claim 9 with a weight percent of at least 10% wheat bran, 18% potato flour, 10% corn dried distiller's grains, 29% rice bran whole, 11% rice bran defatted, 10% canola meal, 7% brewery distiller's grains, or 5% oat hulls.

13. A mealworm diet comprising potato flour, corn dried distiller's grains, rice bran whole, rice bran defatted, canola meal, brewery distiller's grains, and peanut hulls.

14. A diet composition of claim 13 where the efficiency of conversion of ingested food measured by the ratio of dry body weight of mealworms to dry weight of food consumed times 100 is about 9.6.

15. A diet composition of claim 13 where the development time of mealworms is as few as about 144 days.

16. The diet of claim 13 with a weight percent of at least 21% potato flour, 10% corn dried distiller's grains, 30% rice bran whole, 12% rice bran defatted, 11% canola meal, 11% brewery distiller's grainsor 5% peanut hulls.

17. The method of feeding mealworms comprising:
administering a diet comprising wheat bran, potato flour, corn dried distiller's grains, rice bran whole, rice bran defatted, canola meal, brewery distiller's grains, peanut hulls and oat hulls or combinations thereof.

18. The method of claim 17, wherein the diet includes a weight percent of at least 20% potato flour, 10% corn dried distiller's grains, 20% rice bran whole, 36% rice bran defatted, 7% canola meal, or 7% oat hulls.

19. The method of claim 17, wherein the diet includes a weight percent of at least 21% potato flour, 10% corn dried distiller's grains, 30% rice bran whole, 12% rice bran defatted, 11% canola meal, 11% brewery distiller's grainsor 5% peanut hulls.

20. The method of claim 17, wherein the diet includes a weight percent of at least 10% wheat bran, 18% potato flour, 10% corn dried distiller's grains, 29% rice bran whole, 11% rice bran defatted, 10% canola meal, 7% brewery distiller's grains, or 5% oat hulls.

21. The method of claim 17, wherein the diet includes a weight percent of at least 30% wheat bran, 20% corn dried distiller's grains, 35% rice bran whole, 10% brewery distiller's grains, or 5% oat hulls.
